(19) United States
(12) Patent Application Publication
(10) Pub. No.: US 2025/0238887 A1
(43) Pub. Date: Jul. 24, 2025

(54) METHOD FOR PROVIDING SECURITY SERVICES

(71) Applicant: BitHuman Inc, SAN FRANCISCO, CA (US)

(72) Inventors: Steve Gu, Lafayette, CA (US); Yun Fu, Newton, MA (US)

(73) Assignee: BitHuman Inc, SAN FRANCISCO, CA (US)

(21) Appl. No.: 18/420,866

(22) Filed: Jan. 24, 2024

(51) Int. Cl. G06Q 50/26; G06V 20/52; G06V 40/16; G06V 40/20

(52) U.S. Cl. CPC G06Q 50/265; G06V 20/52; G06V 40/173; G06V 40/20

(57) ABSTRACT

Embodiments of the present disclosure may include a method for providing security services with a virtual security guard with artificial intelligence by an artificial intelligence system within a network of stores.

### BACKGROUND OF THE INVENTION

Embodiments of the present disclosure may include a method for providing security services with a virtual security guard with artificial intelligence by an artificial intelligence system within a network of stores.

### BRIEF SUMMARY

Embodiments of the present disclosure may include a method for providing security services with a virtual security guard with artificial intelligence by an artificial intelligence system within a network of stores, the method including detecting, by one or more processors and a set of cameras coupled to the one or more processors, a user entering any store of the network of stores.

In some embodiments, an artificial intelligence engine may be coupled to the one or more processors and a server. In some embodiments, the artificial intelligence engine may be trained by human experts. In some embodiments, the virtual security guard may be configured to be displayed in LED/OLED displays, Android/iOS tablets, Laptops/PCs, smartphones, or VR/AR goggles.

In some embodiments, a set of multi-layer info panels coupled to the one or more processors may be configured to overlay graphics on top of the virtual security guard. In some embodiments, the artificial intelligence system may be configured to protect privacy of customers through edge computing and AI enabled data protection. Embodiments may also include detecting and tracking the user's face, eye, pose, and behavior by the set of cameras coupled to the one or more processors.

Embodiments may also include detecting the user's voice by a set of microphones coupled to the one or more processors. In some embodiments, the set of microphones may be connected to loudspeakers. In some embodiments, the set of microphones may be enabled to be beamforming. In some embodiments, the virtual security guard may be configured to be created based on the appearance of a real human character.

In some embodiments, the virtual security guard's appearance may be configured to be similar to a real human security guard. Embodiments may also include capturing customer behaviors of the user in the store. Embodiments may also include recognizing suspicious behaviors by the AI engine with a set of rules and machine learning models that may be configured to detect any suspicious behavior.

Embodiments may also include recording the suspicious activities of the user or any user. Embodiments may also include raising alarm when suspicious behaviors may be classified as illegal activities that reach a pre-set threshold by the AI engine. In some embodiments, the pre-set threshold may be adjustable by one or more store managers within the set of stores.

Embodiments may also include searching within a set of databases, by the AI engine and the virtual security guard, to check if the suspect had suspicious activities from different sites or stores within the network of stores. Embodiments may also include identifying suspect based on face recognition or re-identification and information from the set of databases.

Embodiments may also include warning the suspect, by the virtual security guard, and announcing that previous suspicious activity records have been retrieved and results will be provided to law reinforcement. Embodiments may also include raising alarm with much loud volume when the AI engine and the visual guard detect the suspect remaining in the store. Embodiments may also include shutting entrances of the store. Embodiments may also include notifying law enforcement.

Embodiments of the present disclosure may also include a method for providing security services with a virtual security guard with artificial intelligence by an artificial intelligence system within a network of stores, the method including detecting, by one or more processors and cameras coupled to the one or more processors, a user entering in any store of the network of stores.

In some embodiments, an artificial intelligence engine may be coupled to the one or more processors and a server. In some embodiments, the artificial intelligence engine may be trained by human experts in the field. In some embodiments, the virtual security guard may be configured to be displayed in LED/OLED displays, Android/iOS tablets, Laptops/PCs, smartphones, or VR/AR goggles.

In some embodiments, a set of multi-layer info panels coupled to the one or more processors may be configured to overlay graphics on top of the virtual security guard. In some embodiments, the virtual security guard may be coupled to the artificial intelligence engine. In some embodiments, the artificial intelligence system may be configured to protect privacy of customers through edge computing and AI enabled data protection.

Embodiments may also include detecting and tracking the user's face, eye, pose, and behavior by a set of outward-facing cameras coupled to the one or more processors. Embodiments may also include detecting the user's voice by a set of microphones coupled to the one or more processors. In some embodiments, the set of microphones may be connected to loudspeakers.

In some embodiments, the set of microphones may be enabled to be beamforming. In some embodiments, the virtual security guard may be configured to be created based on the appearance of a real human character. In some embodiments, the virtual security guard's appearance may be configured to be similar to a real human security guard.

Embodiments may also include capturing customer behaviors of the user in the store. Embodiments may also include recognizing suspicious behaviors by the AI engine with a set of rules and machine learning models that may be configured to detect any suspicious behavior. Embodiments may also include recording the suspicious activities of the user or any user.

Embodiments may also include raising alarm when the suspicious behaviors may be classified as illegal activities with high confidence by the AI engine. Embodiments may also include retrieving a set of databases, by the AI engine and the virtual security guard, to see if the suspect had suspicious activities from different sites or stores within the network of stores.

Embodiments may also include identifying suspect based on face recognition or re-identification and information from the set of databases. Embodiments may also include warning the suspect, by the virtual security guard, and announcing that previous suspicious activity records have been retrieved and results will be provided to law reinforcement. Embodiments may also include raising alarm with much loud volume when the AI engine and the visual guard detect the suspect remains in the store.

Embodiments of the present disclosure may also include a method for providing security services with a virtual security guard with artificial intelligence by an artificial intelligence system within a network of stores, the method including detecting, by one or more processors and a set of cameras coupled to the one or more processors, a user entering any store of the network of stores.

In some embodiments, an artificial intelligence engine may be coupled to the one or more processors and a server. In some embodiments, the artificial intelligence engine may be trained by human experts in the field. In some embodiments, the virtual security guard may be configured to be displayed in LED/OLED displays, Android/iOS tablets, Laptops/PCs, smartphones, or VR/AR goggles.

In some embodiments, a set of multi-layer info panels coupled to the one or more processors may be configured to overlay graphics on top of the virtual security guard. In some embodiments, the virtual security guard may be coupled to the artificial intelligence engine. In some embodiments, the artificial intelligence system may be configured to protect privacy of customers through edge computing and AI enabled data protection.

Embodiments may also include detecting and tracking the user's face, eye, pose and behavior by the set of cameras coupled to the one or more processors. Embodiments may also include detecting the user's voice by a set of microphones coupled to the one or more processors. In some embodiments, the set of microphones may be connected to loudspeakers.

In some embodiments, the set of microphones may be enabled to be beamforming. In some embodiments, the virtual security guard may be configured to be created based on the appearance of a real human character. In some embodiments, the virtual security guard's appearance may be configured to be similar to a real human security guard.

Embodiments may also include capturing customer behaviors of the user in the store. Embodiments may also include recognizing suspicious behaviors by the AI engine with a set of rules and machine learning models that may be configured to detect any suspicious behavior. Embodiments may also include recording the suspicious activities of the user or any user.

Embodiments may also include raising alarm when the suspicious behaviors may be classified as illegal activities with high confidence by the AI engine. Embodiments may also include retrieving a set of databases, by the AI engine and the virtual security guard, to see if the suspect had suspicious activities from different sites or stores within the network of stores. Embodiments may also include identifying the suspect based on face recognition or re-identification. Embodiments may also include warning the suspect and announcing that previous suspicious activity records have been retrieved and results will be provided to law reinforcement.

### BRIEF DESCRIPTION OF THE FIGURES

FIG. 1A is a flowchart illustrating a method for providing security services, according to some embodiments of the present disclosure.

FIG. 1B is a flowchart extending from FIG. 1A and further illustrating the method for providing security services, according to some embodiments of the present disclosure.

FIG. 2A is a flowchart illustrating a method for providing security services, according to some embodiments of the present disclosure.

FIG. 2B is a flowchart extending from FIG. 2A and further illustrating the method for providing security services, according to some embodiments of the present disclosure.

FIG. 3A is a flowchart illustrating a method for providing security services, according to some embodiments of the present disclosure.

FIG. 3B is a flowchart extending from FIG. 3A and further illustrating the method for providing security services, according to some embodiments of the present disclosure.

FIG. 4 is a diagram showing an example of a method for providing security services, according to some embodiments of the present disclosure.

FIG. 5 is a diagram showing a second example of a method for providing security services, according to some embodiments of the present disclosure.

FIG. 6 is a diagram showing a third example of a method for providing security services, according to some embodiments of the present disclosure.

FIG. 7 is a diagram showing a fourth example of a method for providing security services, according to some embodiments of the present disclosure.

FIG. 8 is a diagram showing a fifth example of a method for providing security services, according to some embodiments of the present disclosure.

FIG. 9 is a diagram showing a sixth example of a method for providing security services, according to some embodiments of the present disclosure.

FIG. 10 is a diagram showing a seventh example of a method for providing security services, according to some embodiments of the present disclosure.

### DETAILED DESCRIPTION

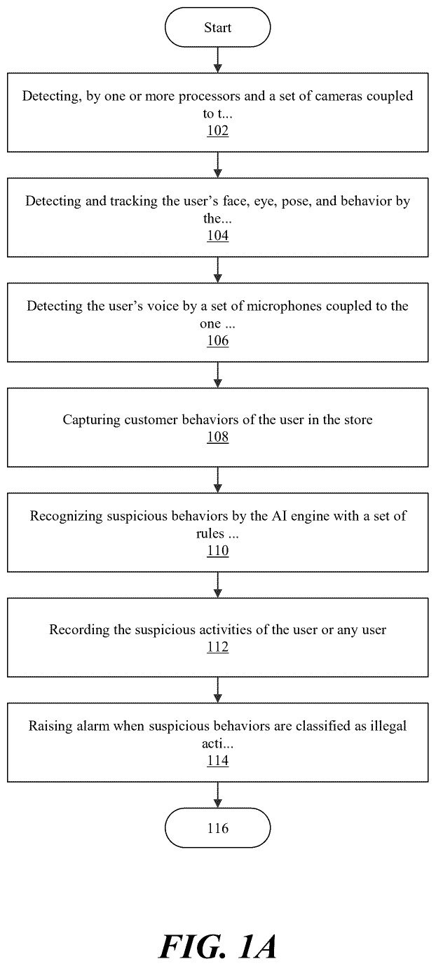

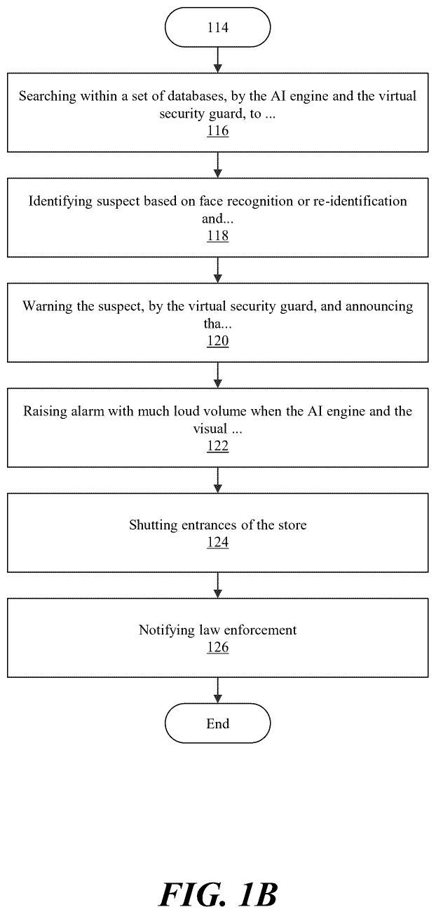

FIGS. 1A to 1B are flowcharts that describe a method for providing security services, according to some embodiments of the present disclosure. In some embodiments, at 102, the method may include detecting, by one or more processors and a set of cameras coupled to the one or more processors, a user entering any store of the network of stores. At 104, the method may include detecting and tracking the user's face, eye, pose, and behavior by the set of cameras coupled to the one or more processors. At 106, the method may include detecting the user's voice by a set of microphones coupled to the one or more processors.

In some embodiments, at 108, the method may include capturing customer behaviors of the user in the store. At 110, the method may include recognizing suspicious behaviors by the AI engine with a set of rules and machine learning models that may be configured to detect any suspicious behavior. At 112, the method may include recording the suspicious activities of the user or any user. At 114, the method may include raising alarm when suspicious behaviors may be classified as illegal activities that reach a pre-set threshold by the AI engine.

In some embodiments, at 116, the method may include searching within a set of databases, by the AI engine and the virtual security guard, to check if the suspect had suspicious activities from different sites or stores within the network of stores. At 118, the method may include identifying suspect based on face recognition or re-identification and information from the set of databases. At 120, the method may include warning the suspect, by the virtual security guard, and announcing that previous suspicious activity records have been retrieved and results will be provided to law reinforcement. At 122, the method may include raising alarm with much loud volume when the AI engine and the visual guard detect the suspect remaining in the store. At 124, the method may include shutting entrances of the store. At 126, the method may include notifying law enforcement.

In some embodiments, an artificial intelligence engine may be coupled to the one or more processors and a server. The artificial intelligence engine may be trained by human experts. The virtual security guard may be configured to be displayed in LED/OLED displays, Android/iOS tablets, Laptops/PCs, smartphones, or VR/AR goggles. A set of multi-layer info panels coupled to the one or more processors may be configured to overlay graphics on top of the virtual security guard.

In some embodiments, the artificial intelligence system may be configured to protect privacy of customers through edge computing and AI enabled data protection. The set of microphones may be connected to loudspeakers. The set of microphones may be enabled to be beamforming. The virtual security guard may be configured to be created based on the appearance of a real human character. The virtual security guard's appearance may be configured to be similar to a real human security guard. The pre-set threshold may be adjustable by one or more store managers within the set of stores.

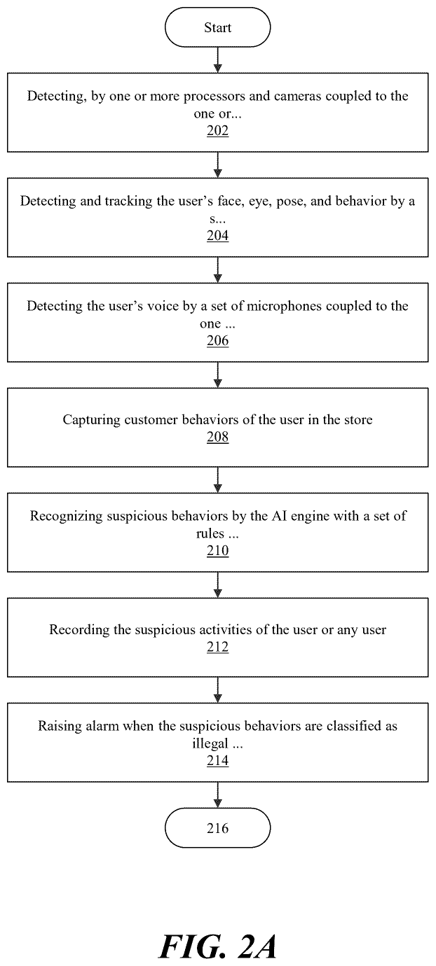

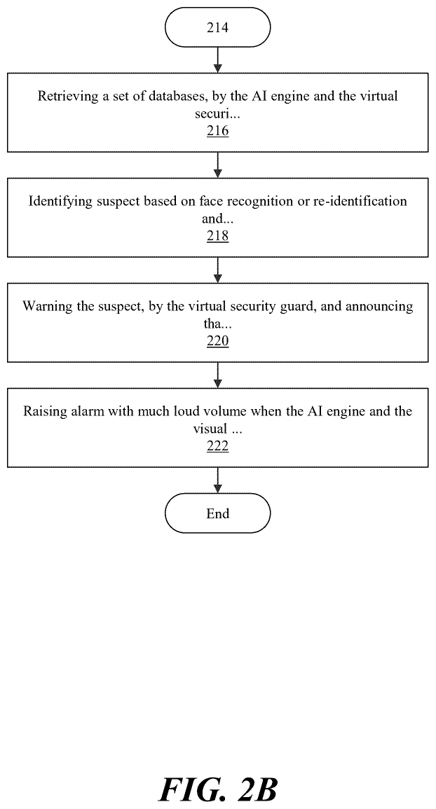

FIGS. 2A to 2B are flowcharts that describe a method for providing security services, according to some embodiments of the present disclosure. In some embodiments, at 202, the method may include detecting, by one or more processors and cameras coupled to the one or more processors, a user entering in any store of the network of stores. At 204, the method may include detecting and tracking the user's face, eye, pose, and behavior by a set of outward-facing cameras coupled to the one or more processors. At 206, the method may include detecting the user's voice by a set of microphones coupled to the one or more processors.

In some embodiments, at 208, the method may include capturing customer behaviors of the user in the store. At 210, the method may include recognizing suspicious behaviors by the AI engine with a set of rules and machine learning models that may be configured to detect any suspicious behavior. At 212, the method may include recording the suspicious activities of the user or any user. At 214, the method may include raising alarm when the suspicious behaviors may be classified as illegal activities with high confidence by the AI engine.

In some embodiments, at 216, the method may include retrieving a set of databases, by the AI engine and the virtual security guard, to see if the suspect had suspicious activities from different sites or stores within the network of stores. At 218, the method may include identifying suspect based on face recognition or re-identification and information from the set of databases. At 220, the method may include warning the suspect, by the virtual security guard, and announcing that previous suspicious activity records have been retrieved and results will be provided to law reinforcement. At 222, the method may include raising alarm with much loud volume when the AI engine and the visual guard detect the suspect remains in the store.

In some embodiments, an artificial intelligence engine may be coupled to the one or more processors and a server. The artificial intelligence engine may be trained by human experts in the field. The virtual security guard may be configured to be displayed in LED/OLED displays, Android/iOS tablets, Laptops/PCs, smartphones, or VR/AR goggles. A set of multi-layer info panels coupled to the one or more processors may be configured to overlay graphics on top of the virtual security guard.

In some embodiments, the virtual security guard may be coupled to the artificial intelligence engine. The artificial intelligence system may be configured to protect privacy of customers through edge computing and AI enabled data protection. The set of microphones may be connected to loudspeakers. The set of microphones may be enabled to be beamforming. The virtual security guard may be configured to be created based on the appearance of a real human character. The virtual security guard's appearance may be configured to be similar to a real human security guard.

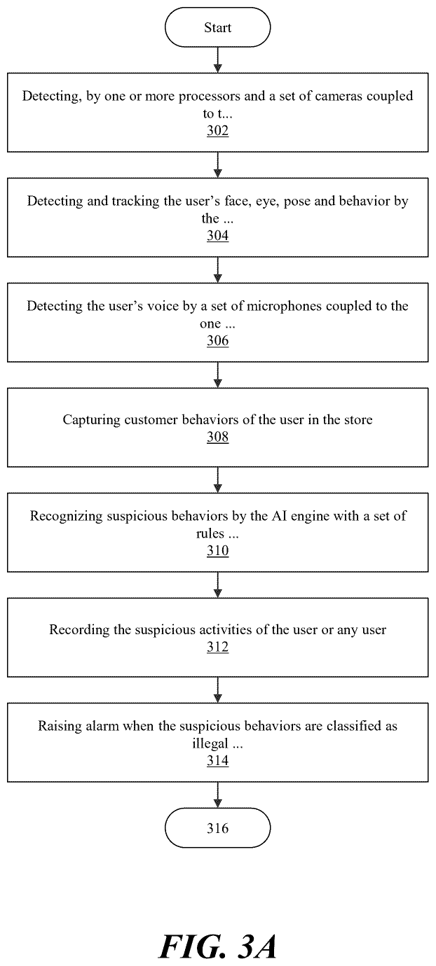

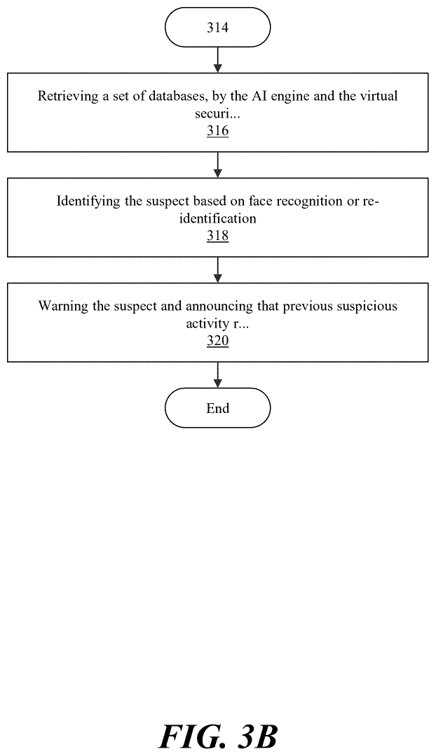

FIGS. 3A to 3B are flowcharts that describe a method for providing security services, according to some embodiments of the present disclosure. In some embodiments, at 302, the method may include detecting, by one or more processors and a set of cameras coupled to the one or more processors, a user entering any store of the network of stores. At 304, the method may include detecting and tracking the user's face, eye, pose and behavior by the set of cameras coupled to the one or more processors. At 306, the method may include detecting the user's voice by a set of microphones coupled to the one or more processors.

In some embodiments, at 308, the method may include capturing customer behaviors of the user in the store. At 310, the method may include recognizing suspicious behaviors by the AI engine with a set of rules and machine learning models that may be configured to detect any suspicious behavior. At 312, the method may include recording the suspicious activities of the user or any user. At 314, the method may include raising alarm when the suspicious behaviors may be classified as illegal activities with high confidence by the AI engine.

In some embodiments, at 316, the method may include retrieving a set of databases, by the AI engine and the virtual security guard, to see if the suspect had suspicious activities from different sites or stores within the network of stores. At 318, the method may include identifying the suspect based on face recognition or re-identification. At 320, the method may include warning the suspect and announcing that previous suspicious activity records have been retrieved and results will be provided to law reinforcement.

In some embodiments, an artificial intelligence engine may be coupled to the one or more processors and a server. The artificial intelligence engine may be trained by human experts in the field. The virtual security guard may be configured to be displayed in LED/OLED displays, Android/iOS tablets, Laptops/PCs, smartphones, or VR/AR goggles. A set of multi-layer info panels coupled to the one or more processors may be configured to overlay graphics on top of the virtual security guard. In some embodiments, the virtual security guard may be coupled to the artificial intelligence engine. The artificial intelligence system may be configured to protect privacy of customers through edge computing and AI enabled data protection. The set of microphones may be connected to loudspeakers. The set of microphones may be enabled to be beamforming. The virtual security guard may be configured to be created based on the appearance of a real human character. The virtual security guard's appearance may be configured to be similar to a real human security guard.

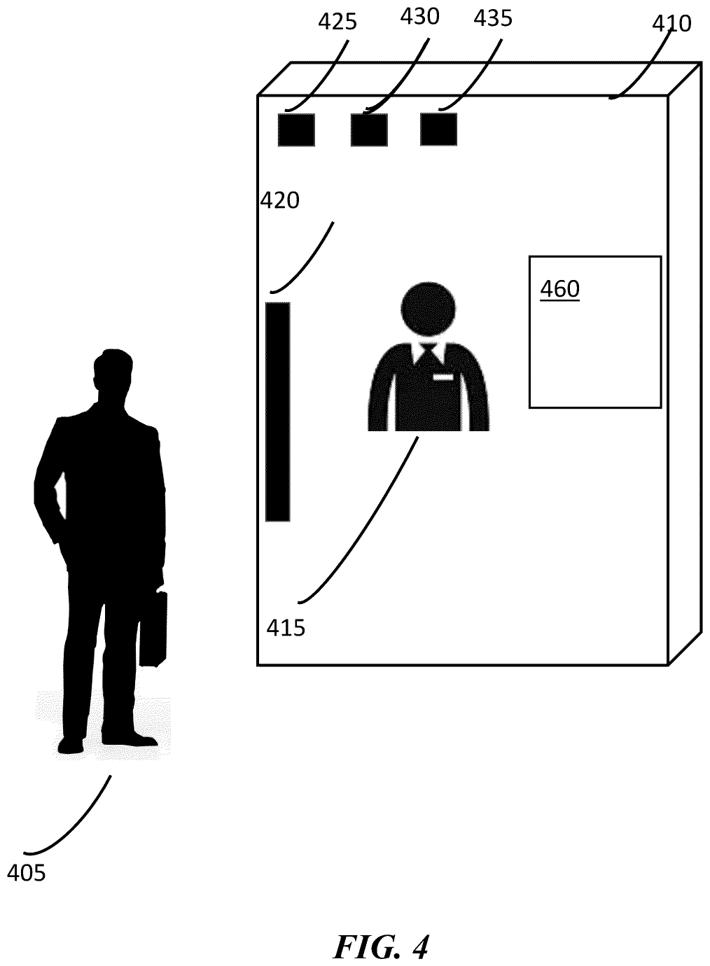

FIG. 4 is a diagram showing an example that describes a first example of a method for providing security services, according to some embodiments of the present disclosure. In some embodiments, a user 405 can approach a smart display 410. In some embodiments, the smart display 410 could be LED or OLED-based. In some embodiments, interactive panels 420 are attached to the smart display 410. In some embodiments, camera 425, sensor 430 and microphone 435 are attached to the smart display 410. In some embodiments, an artificial intelligence visual assistant 415 is active on the smart display 410. In some embodiments, a visual working agenda 460 is shown on the smart display 410. In some embodiments, user 405 can approach the smart display 410 and initiate and complete the intended business with the visual assistant 415 by the methods described in FIG. 1-FIG. 3. In some embodiments, interactive panel 420 is coupled to a central processor. In some embodiments, interactive panel 420 is coupled to a server via a wireless link. In some embodiments, user 405 can interact with the visual assistant 415 via camera 425, sensor 430 and microphone 435 using methods described in FIG. 1-FIG. 3, with the help of interactive panel 420. In some embodiments, user 405 can choose what language to use. In some embodiments, other users can use this service described in this paragraph. In some embodiments, the user is able to interact with multiple AI visual assistants as described in this example and methods described in FIG. 1-3.

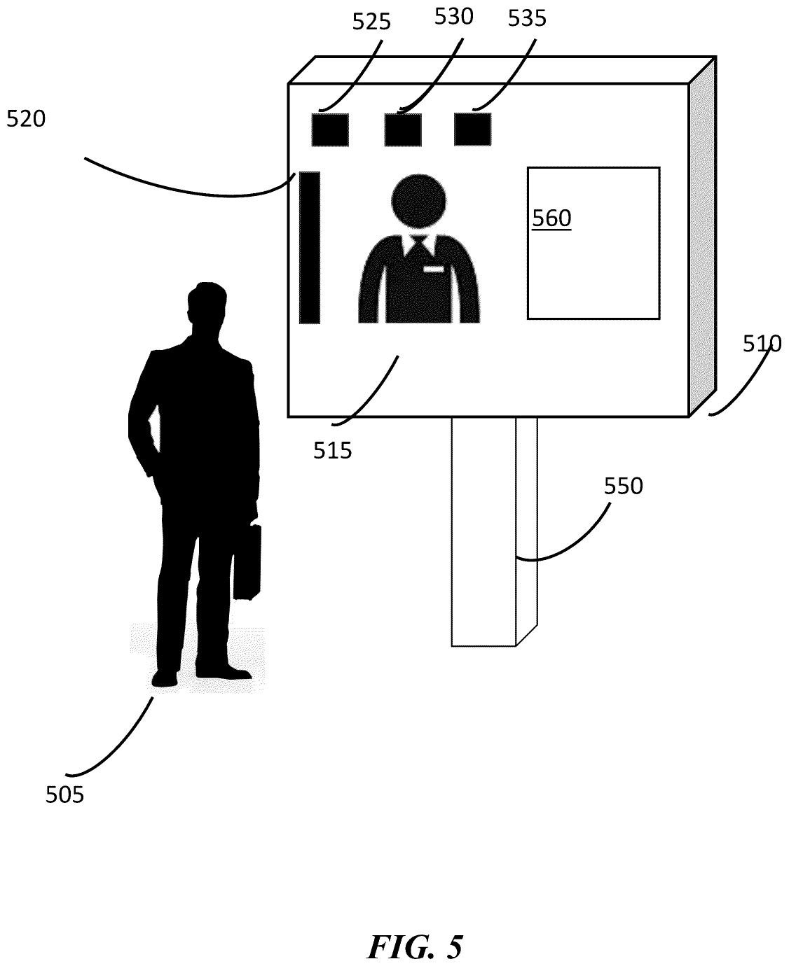

FIG. 5 is a diagram showing a second example of a method for providing security services, according to some embodiments of the present disclosure.

In some embodiments, a user 505 can approach a smart display 510. In some embodiments, the smart display 510 could be LED or OLED-based. In some embodiments, interactive panels 520 are attached to the smart display 510. In some embodiments, camera 525, sensor 530, and microphone 535 are attached to the smart display 510. In some embodiments, a support column 550 is attached to the smart display 510. In some embodiments, an artificial intelligence visual assistant 515 is active on the smart display 510. In some embodiments, a visual working agenda 560 is shown on the smart display 510. In some embodiments, user 505 can approach the smart display 510 and initiate and complete the business process with the visual assistant 515 by the methods described in FIG. 1-FIG. 3. In some embodiments, interactive panel 520 is coupled to a central processor. In some embodiments, interactive panel 520 is coupled to a server via a wireless link. In some embodiments, user 505 can interact with the visual assistant 515 via camera 525, sensor 530 and microphone 535 using methods described in FIG. 1-FIG. 3, with the help of interactive panel 520. In some embodiments, user 505 can choose what language to be used. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

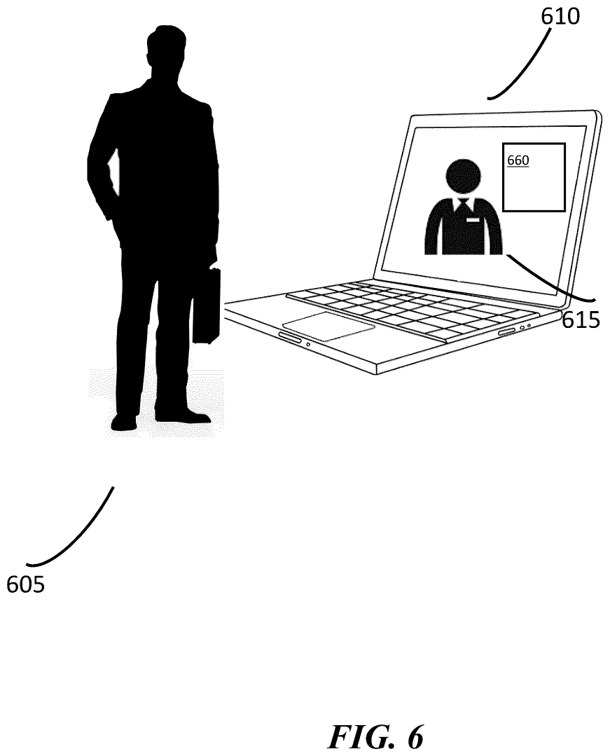

FIG. 6 is a diagram showing a third example of a method for providing security services, according to some embodiments of the present disclosure.

In some embodiments, a user 605 can approach a smart display 610. In some embodiments, the smart display 610 could be LED or OLED-based. In some embodiments, the display 610 could be a part of a desktop computer, a laptop computer or a tablet computer. In some embodiments, a camera, sensor, and microphone are attached to the smart display 610. In some embodiments, an artificial intelligence visual assistant 615 is active on the smart display 610. In some embodiments, a visual working agenda 660 is shown on the smart display 610. In some embodiments, user 605 can approach the smart display 610 and initiate and complete the business process with the visual assistant 615 by the methods described in FIG. 1-FIG. 3. In some embodiments, a keyboard is coupled to a central processor. In some embodiments, a keyboard is coupled to a server via a wireless link. In some embodiments, user 605 can interact with the visual assistant 615 via a camera, sensor and microphone using methods described in FIG. 1-FIG. 3, with the help of the keyboard. In some embodiments, user 605 can choose what language to use. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

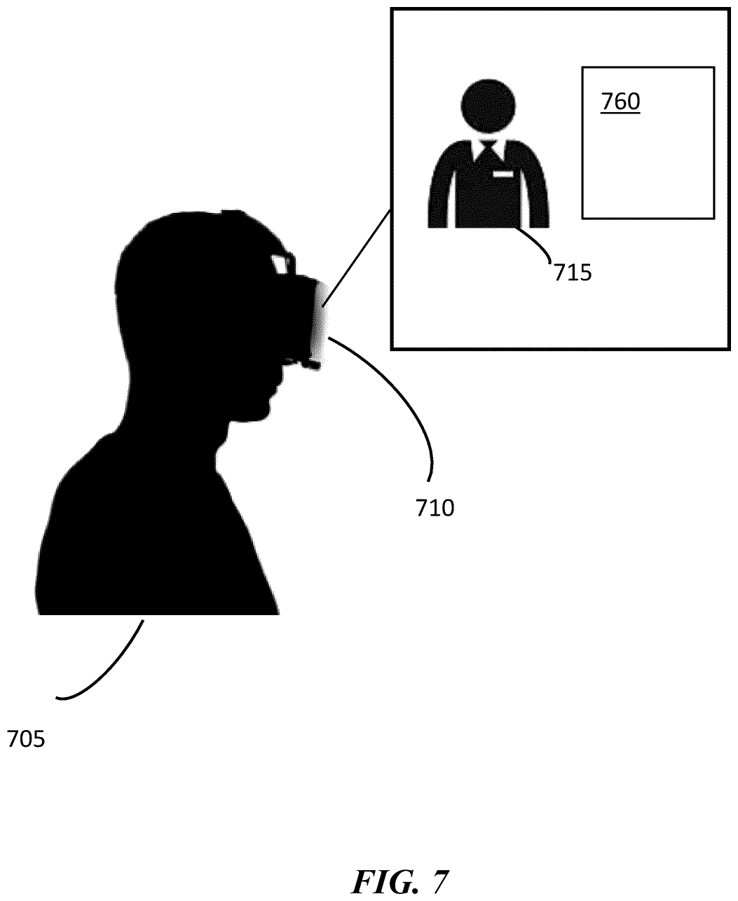

FIG. 7 is a diagram showing a fourth example of a method for providing security services, according to some embodiments of the present disclosure.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual assistant 715 is active on the VR or AR device 710. In some embodiments, a visual working agenda 760 is shown on the VR or AR 710. In some embodiments, user 705 can initiate and complete the business process with the visual assistant 705 via the VR or AR device 715 by the methods described in FIG. 1-FIG. 3. In some embodiments, an interactive panel is coupled to a central processor. In some embodiments, an interactive panel is coupled to a server via a wireless link. In some embodiments, the user 705 can choose what language to use. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

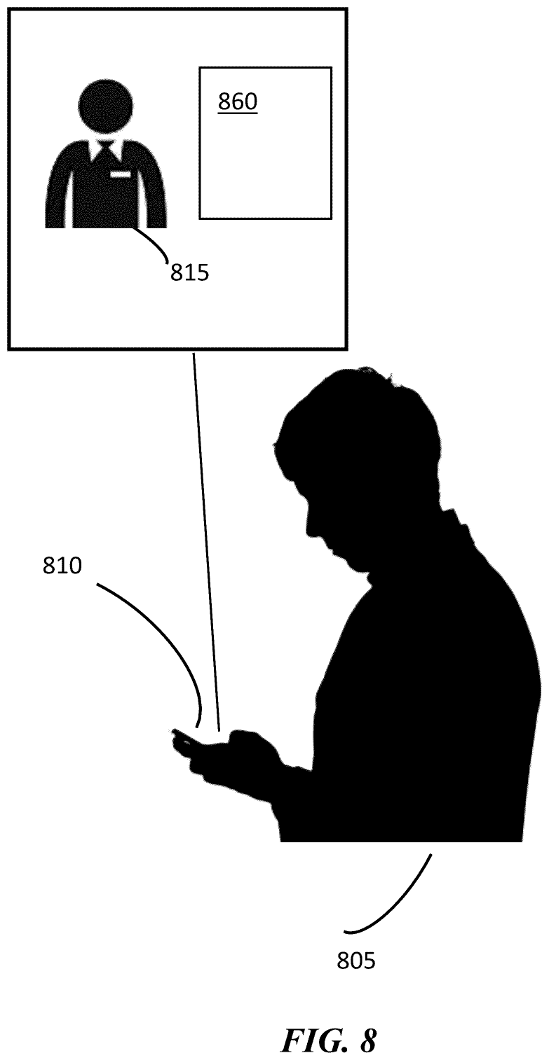

FIG. 8 is a diagram showing a fifth example of a method for providing security services, according to some embodiments of the present disclosure.

In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual assistant 815 is active on the smartphone device 810. In some embodiments, a visual working agenda 860 is shown on the smartphone device 810. In some embodiments, user 805 can initiate and complete the business process with the visual assistant 815 via smartphone device 810 by the methods described in FIG. 1-FIG. 3. In some embodiments, an interactive panel is coupled to a central processor. In some embodiments, interactive panel is coupled to a server via a wireless link. In some embodiments, the user 805 can choose what language to be used. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

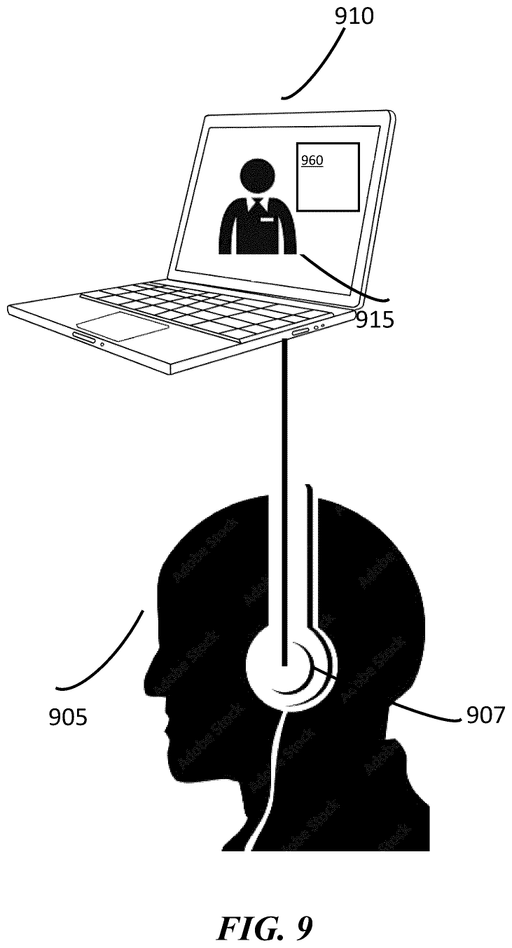

FIG. 9 is a diagram showing a sixth example of a method for providing security services, according to some embodiments of the present disclosure.

In some embodiments, a user 905 has a brain-computer interface. In some embodiments, the user 905 may wear a headset 907 that can detect and translate the electric signal from the brain and communicate with the computer or other devices. The computer 910 or other devices are connected with a cable or wire to the headset. In some embodiments, a processor and a server are connected to the computer 910. In some embodiments, an interactive keyboard is connected to the computer 910. In some embodiments, an AI visual assistant 915 is active on the computer 910. In some embodiments, a visual working agenda 960 is shown on the computer 910. In some embodiments, user 905 can initiate and complete the business process with the visual assistant 905 via the computer 915 by the methods described in FIG. 1-FIG. 3. In some embodiments, an interactive panel is coupled to a central processor. In some embodiments, an interactive panel is coupled to a server via a wireless link. In some embodiments, the user 905 can choose what language to use. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

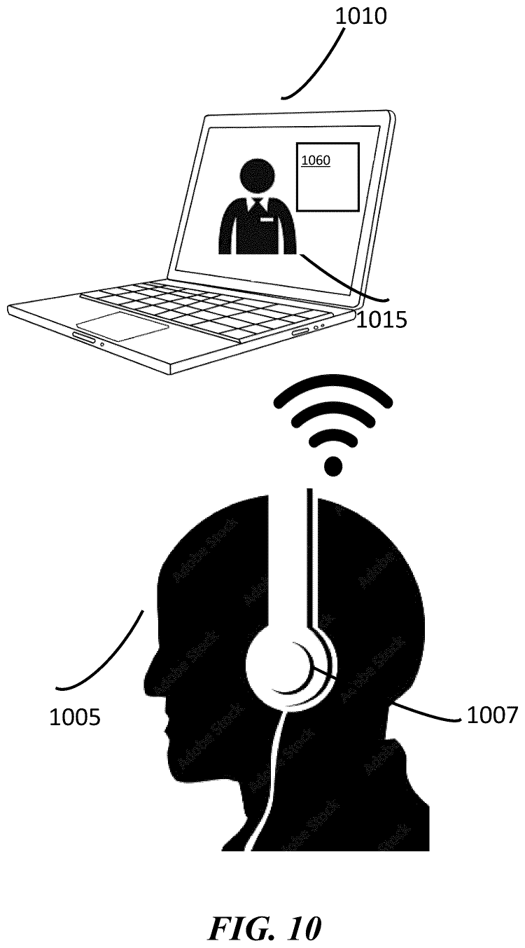

FIG. 10 is a diagram showing a seventh example of a method for providing security services, according to some embodiments of the present disclosure.

In some embodiments, a user 1005 has a brain-computer interface. In some embodiments, the user 1005 may wear a headset 1007 that can detect and translate the electric signal from the brain and communicate with the computer or other devices. The computer 1010 or other devices are connected with wireless means to the headset. In some embodiments, a processor and a server are connected to the computer 1010. In some embodiments, an interactive keyboard is connected to the computer 1010. In some embodiments, an AI visual assistant 1015 is active on the computer 1010. In some embodiments, a visual working agenda 1060 is shown on the computer 1010. In some embodiments, user 1005 can initiate and complete the business process with the visual assistant 1005 via the computer 1015 by the methods described in FIG. 1-FIG. 3. In some embodiments, an interactive panel is coupled to a central processor. In some embodiments, an interactive panel is coupled to a server via a wireless link. In some embodiments, the user 1005 can choose what language to use. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

1. A method for providing security services with a virtual security guard with artificial intelligence by an artificial intelligence system within a network of stores, the method comprising:
detecting, by one or more processors and a set of cameras coupled to the one or more processors, a user entering any store of the network of stores, wherein an artificial intelligence engine is coupled to the one or more processors and a server, wherein the artificial intelligence engine is trained by human experts, wherein the virtual security guard is configured to be displayed in LED/OLED displays, Android/iOS tablets, Laptops/PCs, smartphones, or VR/AR goggles, wherein a set of multi-layer info panels coupled to the one or more processors are configured to overlay graphics on top of the virtual security guard, wherein the artificial intelligence system is configured to protect privacy of customers through edge computing and AI enabled data protection;
detecting and tracking the user's face, eye, pose, and behavior by the set of cameras coupled to the one or more processors;
detecting the user's voice by a set of microphones coupled to the one or more processors, wherein the set of microphones are connected to loudspeakers, wherein the set of microphones are enabled to be beamforming, wherein the virtual security guard is configured to be created based on the appearance of a real human character, wherein the virtual security guard's appearance is configured to be similar to a real human security guard;
capturing customer behaviors of the user in the store;
recognizing suspicious behaviors by the AI engine with a set of rules and machine learning models that are configured to detect any suspicious behavior;
recording the suspicious activities of the user or any user;
raising alarm when suspicious behaviors are classified as illegal activities that reach a pre-set threshold by the AI engine, wherein the pre-set threshold is adjustable by one or more store managers within the set of stores;
searching within a set of databases, by the AI engine and the virtual security guard, to check if the suspect had suspicious activities from different sites or stores within the network of stores;
identifying suspect based on face recognition or re-identification and information from the set of databases;
warning the suspect, by the virtual security guard, and announcing that previous suspicious activity records have been retrieved and results will be provided to law reinforcement;
raising alarm with much loud volume when the AI engine and the visual guard detect the suspect remaining in the store;
shutting entrances of the store; and
notifying law enforcement.

2. A method for providing security services with a virtual security guard with artificial intelligence by an artificial intelligence system within a network of stores, the method comprising:
detecting, by one or more processors and cameras coupled to the one or more processors, a user entering in any store of the network of stores, wherein an artificial intelligence engine is coupled to the one or more processors and a server, wherein the artificial intelligence engine is trained by human experts in the field, wherein the virtual security guard is configured to be displayed in LED/OLED displays, Android/iOS tablets, Laptops/PCs, smartphones, or VR/AR goggles, wherein a set of multi-layer info panels coupled to the one or more processors are configured to overlay graphics on top of the virtual security guard, wherein the virtual security guard is coupled to the artificial intelligence engine, wherein the artificial intelligence system is configured to protect privacy of customers through edge computing and AI enabled data protection;
detecting and tracking the user's face, eye, pose, and behavior by a set of outward-facing cameras coupled to the one or more processors;
detecting the user's voice by a set of microphones coupled to the one or more processors, wherein the set of microphones are connected to loudspeakers, wherein the set of microphones are enabled to be beamforming, wherein the virtual security guard is configured to be created based on the appearance of a real human character, wherein the virtual security guard's appearance is configured to be similar to a real human security guard;
capturing customer behaviors of the user in the store;
recognizing suspicious behaviors by the AI engine with a set of rules and machine learning models that are configured to detect any suspicious behavior;
recording the suspicious activities of the user or any user;
raising alarm when the suspicious behaviors are classified as illegal activities with high confidence by the AI engine;
retrieving a set of databases, by the AI engine and the virtual security guard, to see if the suspect had suspicious activities from different sites or stores within the network of stores;
identifying suspect based on face recognition or re-identification and information from the set of databases;
warning the suspect, by the virtual security guard, and announcing that previous suspicious activity records have been retrieved and results will be provided to law reinforcement;
raising alarm with much loud volume when the AI engine and the visual guard detect the suspect remains in the store.

3. A method for providing security services with a virtual security guard with artificial intelligence by an artificial intelligence system within a network of stores, the method comprising:
detecting, by one or more processors and a set of cameras coupled to the one or more processors, a user entering any store of the network of stores, wherein an artificial intelligence engine is coupled to the one or more processors and a server, wherein the artificial intelligence engine is trained by human experts in the field, wherein the virtual security guard is configured to be displayed in LED/OLED displays, Android/iOS tablets, Laptops/PCs, smartphones, or VR/AR goggles, wherein a set of multi-layer info panels coupled to the one or more processors are configured to overlay graphics on top of the virtual security guard, wherein the virtual security guard is coupled to the artificial intelligence engine, wherein the artificial intelligence system is configured to protect privacy of customers through edge computing and AI enabled data protection;
detecting and tracking the user's face, eye, pose and behavior by the set of cameras coupled to the one or more processors;
detecting the user's voice by a set of microphones coupled to the one or more processors, wherein the set of microphones are connected to loudspeakers, wherein the set of microphones are enabled to be beamforming, wherein the virtual security guard is configured to be created based on the appearance of a real human character, wherein the virtual security guard's appearance is configured to be similar to a real human security guard;
capturing customer behaviors of the user in the store;
recognizing suspicious behaviors by the AI engine with a set of rules and machine learning models that are configured to detect any suspicious behavior;
recording the suspicious activities of the user or any user;
raising alarm when the suspicious behaviors are classified as illegal activities with high confidence by the AI engine;
retrieving a set of databases, by the AI engine and the virtual security guard, to see if the suspect had suspicious activities from different sites or stores within the network of stores;
identifying the suspect based on face recognition or re-identification; and
warning the suspect and announcing that previous suspicious activity records have been retrieved and results will be provided to law reinforcement.
